(19) United States
(12) Patent Application Publication
(10) Pub. No.: US 2024/0236241 A1
(43) Pub. Date: Jul. 11, 2024

(54) PROCESSING APPARATUS, NON-TRANSITORY COMPUTER READABLE MEDIUM, AND MANAGEMENT SYSTEM

(71) Applicant: FUJIFILM Business Innovation Corp., Tokyo (JP)

(72) Inventor: Hideki SATO, Kanagawa (JP)

(73) Assignee: FUJIFILM Business Innovation Corp., Tokyo (JP)

(21) Appl. No.: 18/352,354

(22) Filed: Jul. 14, 2023

(30) Foreign Application Priority Data
Jan. 5, 2023 (JP) 2023-000737

(51) Int. Cl. H04N 1/00

(52) U.S. Cl. CPC H04N 1/00037; H04N 1/00076; H04N 1/00915

(57) ABSTRACT

A processing apparatus includes a processor configured to: obtain operational noise data for a predetermined period, the operational noise data being obtained in operation of the apparatus which makes noise caused by the operation; in response to detection of an abnormality in the apparatus from the operational noise data, extract, as analysis target data from the operational noise data, data corresponding to an operating period of a designated component that is designated in advance and that is included in the apparatus; and output the extracted analysis target data to a determination unit that determines presence of the failure state of the designated component.

### CROSS-REFERENCE TO RELATED APPLICATIONS

This application is based on and claims priority under 35 USC 119 from Japanese Patent Application No. 2023-000737 filed Jan. 5, 2023.

### BACKGROUND

### (i) Technical Field

The present disclosure relates to a processing apparatus, a non-transitory computer readable medium, and a management system.

### (ii) Related Art

Japanese Unexamined Patent Application Publication No. 2022-82318 discloses a failure diagnosis apparatus including an acquisition unit, a processing unit, and an estimating unit. When a fuel-cell cogeneration system detects an abnormality in its operation, the acquisition unit acquires, from the fuel-cell cogeneration system, operational history data, which corresponds to the abnormality, about the operational history of the fuel-cell cogeneration system. The processing unit performs first processing, common to multiple failure diagnosis models, on the operational history data acquired by the acquisition unit. The failure diagnosis models are generated through machine learning or multivariate analysis by associating functional units of the fuel-cell cogeneration system with pieces of operational history data obtained in the past. Each failure diagnosis model determines presence of a failure in the corresponding functional unit of the fuel-cell cogeneration system. The processing unit performs second processing on the data obtained through the first processing. The second processing is defined individually for the failure diagnosis models. The estimating unit inputs the pieces of data, which are obtained through the first processing and the second processing by the processing unit, to the respective failure diagnosis models, and uses the determination results, which are output from the respective failure diagnosis models, to estimate presence of a failure in each functional unit of the fuel-cell cogeneration system.

Japanese Unexamined Patent Application Publication No. 2020-38411 discloses a facility maintenance apparatus which maintains a facility including multiple devices of different models. The facility maintenance apparatus includes a noise collector, a storage unit, and an abnormality determination unit. The noise collector obtains noise, caused by the devices, while being moved in the facility, and obtains noise information. In the storage unit, abnormal-noise models of the components included in a device of each model are registered. The abnormality determination unit performs analysis through comparison between the noise information and each abnormal-noise model. When abnormal noise corresponding to an abnormal-noise model is detected from the noise information, the abnormality determination unit determines that the model associated with the abnormal-noise model corresponding to the abnormal noise and the corresponding component have an abnormality.

A known abnormality diagnosis technique employs detection of an abnormality in a device from noise occurring during operation. However, in the related art, an abnormality diagnosis technique using noise involves determination about presence of an abnormality for each component included in a device. Therefore, a device that includes a larger number of components has a heavier load for abnormality diagnosis.

### SUMMARY

Aspects of non-limiting embodiments of the present disclosure relate to a processing apparatus, a non-transitory computer readable medium, and a management system which reduce a load for abnormality diagnosis compared with the case in which presence of an abnormality is determined for each component.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a processing apparatus comprising a processor configured to: obtain operational noise data for a predetermined period, the operational noise data being obtained in operation of the apparatus which makes noise caused by the operation; in response to detection of an abnormality in the apparatus from the operational noise data, extract, as analysis target data from the operational noise data, data corresponding to an operating period of a designated component that is designated in advance and that is included in the apparatus; and output the extracted analysis target data to a determination unit that determines presence of a failure state of the designated component.

### BRIEF DESCRIPTION OF THE DRAWINGS

Exemplary embodiments of the present disclosure will be described in detail based on the following figures, wherein:

FIG. 1 is a diagram illustrating an exemplary configuration of a management system;

FIG. 2 is a diagram illustrating an exemplary functional configuration of an image forming apparatus;

FIG. 3 is an exemplary schematic view of an image forming unit;

FIG. 4 is a diagram illustrating exemplary operational noise data;

FIG. 5 is a diagram illustrating an exemplary partial configuration of an electrical system of an image forming apparatus;

FIG. 6 is a diagram illustrating an exemplary partial configuration of an electrical system of a management server;

FIG. 7 is a flowchart of an exemplary process of starting abnormality detection;

FIG. 8 is a diagram illustrating exemplary operational logs;

FIG. 9 is a flowchart of an exemplary process of obtaining operational noise data;

FIG. 10 is a flowchart of an exemplary process of analyzing operational noise data;

FIG. 11 is a diagram illustrating exemplary profile data;

FIG. 12 is a flowchart of an exemplary process of determining abnormal noise;

FIG. 13 is a flowchart of an exemplary process of extracting analysis target data;

FIG. 14 is a flowchart of an exemplary process, performed by an image forming apparatus, of determining presence of a failure in a designated component; and

FIG. 15 is a flowchart of an exemplary process, performed by a management server, of determining presence of a failure in a designated component.

### DETAILED DESCRIPTION

Exemplary embodiments of the present disclosure will be described below by referring to the drawings. Identical components and identical processes are designated with identical reference numerals in all the drawings, and will not be described repeatedly.

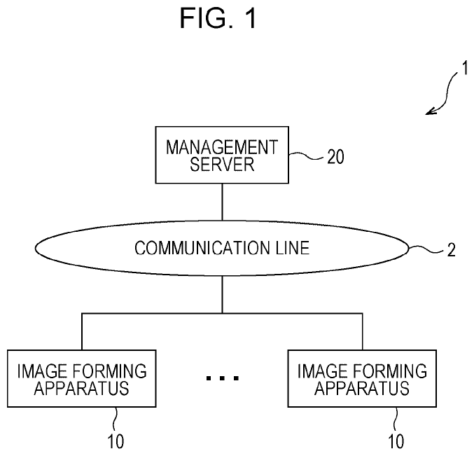

FIG. 1 is a diagram illustrating an exemplary configuration of a management system 1 which manages the operating conditions of image forming apparatuses 10. The management system 1 includes at least one image forming apparatus 10, which performs functions requested by users, and a management server 20 which manages the operating condition of each image forming apparatus 10. Each image forming apparatus 10 and the management server 20 are connected to each other through a communication line 2 such as the Internet.

An image forming apparatus 10 is an exemplary processing apparatus which has at least one function related to image processing. Examples of the function provided by an image forming apparatus 10 include a print function of printing, on a sheet P, an image represented by image data, a scan function of optically reading an image in a document and generating image data, and a copy function of copying, onto another sheet P, an image in a document. For convenience of description, it is assumed that an image forming apparatus 10 has a print function. In the print function, components relevant, for example, to transport of a sheet P on which an image is to be formed, image formation on a sheet P using toner or ink, and fixing of an image formed on a sheet P are operated, and operational noise occur.

When each image forming apparatus 10 performs a function requested by a user, the image forming apparatus 10 transmits, to the management server 20, information about its operating condition.

Any type of processing apparatus may be used instead of an image forming apparatus 10 as long as the processing apparatus makes noise in an operation for a function requested by a user and ends occurrence of the noise at completion of the operation. For example, various types of manufacturing equipment for manufacture of components and driving gears of side windows of vehicles may be connected to the communication line 2 instead of the at least one image forming apparatus 10, and the management server 20 may manage the operating condition of each device.

The management server 20 is an exemplary management apparatus which obtains, from each image forming apparatus 10, information about its operating condition and which performs a process in accordance with the operating condition of each image forming apparatus 10.

There is no limitation on a place where an image forming apparatus 10, whose operating condition is managed by the management server 20, is installed. For example, each image forming apparatus 10 maybe installed in the same building, or the installation may be dispersed throughout the country.

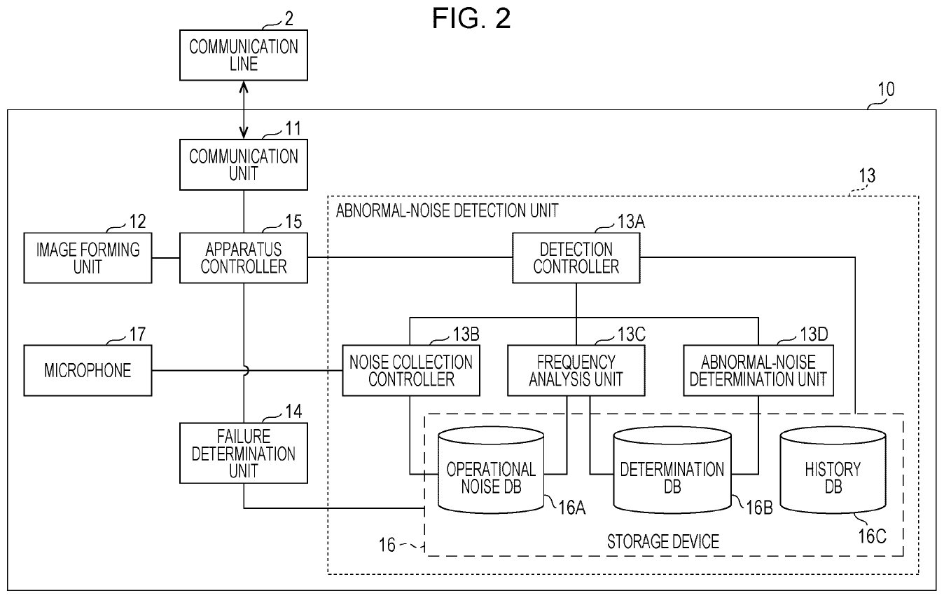

FIG. 2 is a diagram illustrating an exemplary functional configuration of an image forming apparatus 10. The image forming apparatus 10 includes functional units of a communication unit 11, an image forming unit 12, an abnormal-noise detection unit 13, a failure determination unit 14, and an apparatus controller 15. The image forming apparatus 10 also includes a storage device 16 and a microphone 17.

The communication unit 11 performs bidirectional data communication with the management server 20 through the communication line 2. The communication unit 11 may perform bidirectional data communication with the other image forming apparatuses 10. Further, the communication unit 11 may perform bidirectional data communication with an apparatus (referred to as an “external apparatus”) which is other than the other image forming apparatuses 10 and the management server 20 and which is connected to the communication line 2.

When a user transmits an instruction to start the print function, the image forming unit 12 uses an image forming unit 37D to form, on a sheet P by using color material, an image represented by image data which is a print target. There is no limitation on an image formation system in the image forming unit 12. For example, the image formation system may be an inkjet system or an electrophotographic system.

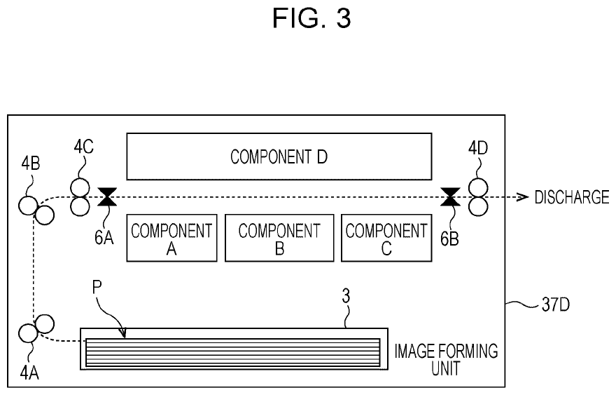

FIG. 3 is an exemplary schematic view of the image forming unit 37D. For example, the image forming unit 37D includes a sheet container 3 in which sheets P are stored, components A to D which are used in image formation on a sheet P, transport rollers 4A to 4D which transport a sheet P, which is stored in the sheet container 3, to a discharge outlet along a transport path (the path indicated by using the dotted line in FIG. 3), detection sensors 6A and 6B which detect a sheet P transported along the transport path.

The schematic view of the image forming unit 37D in FIG. 3 describes operations of the image forming unit 37D schematically. Therefore, the components of the image forming unit 37D and arrangement of the components are different from actual ones of the image forming unit 37D.

The transport rollers 4A to 4D transport sheets P, which are stored in the sheet container 3, one by one along the transport path. When a sheet P is transported between the detection sensor 6A and the detection sensor 6B, the image forming unit 37D forms, on the sheet P, an image represented by image data. To do this, the detection sensor 6A detects the side of the sheet P (referred to as the leading end of the sheet P) that is located downstream in the transport direction and that is orthogonal to the transport direction. In addition, the detection sensor 6B detects the side of the sheet P (referred to as the trailing end of the sheet P) that is located upstream in the transport direction and that is orthogonal to the transport direction. That is, the detection sensors 6A and 6B detect the period from start to end of image formation on a sheet P. The period from start to end of image formation on a single sheet P is referred to as an “image formation period 5”. Such an image formation period 5 is an exemplary predetermined period in the present disclosure.

For convenience of description, the schematic view of the image forming unit 37D in FIG. 3 discriminately illustrates the components A to D, the transport rollers 4A to 4D, and the detection sensors 6A and 6B. The transport rollers 4A to 4D and the detection sensors 6A and 6B are also exemplary components included in the image forming unit 37D. In addition, components (not illustrated in FIG. 3) such as a motor and a belt are also exemplary components included in the image forming unit 37D. The motor drives the transport rollers 4A to 4D. The belt transfers rotation of the motor to the transport rollers 4A to 4D.

The abnormal-noise detection unit 13 detects whether any abnormality occurs in the image forming unit 37D, by using operational noise data which represents operational noise that is caused by the image forming unit 37D and that is collected by the microphone 17 during execution of the print function. To do this, the microphone 17 is installed at a position where operational noise of the image forming unit 37D may be collected, for example, at a position inside or around the image forming unit 37D.

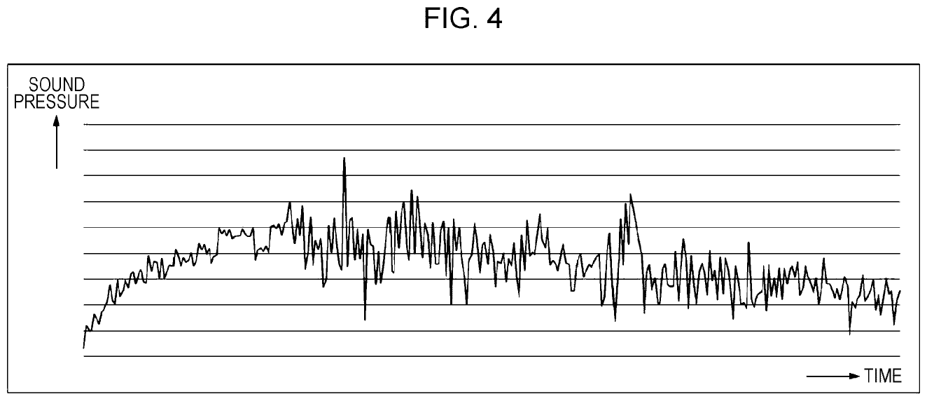

FIG. 4 is a diagram illustrating exemplary operational noise data indicating noise collected by the microphone 17. As illustrated in FIG. 4, the operational noise data represents the magnitudes of noise at each time, that is, time-series sound pressure, and represents live noise collected by the microphone 17.

When an abnormality in the image forming unit 37D is detected, the abnormal-noise detection unit 13 extracts a part of obtained operational noise data as analysis target data and outputs the extracted data to the apparatus controller 15. The part of obtained operational noise data is the operational noise data for the operating period, for example, of a component (referred to as a “designated component”) designated in advance by a manager among the components included in the image forming unit 37D.

A designated component may be a component which stops the operation of the image forming apparatus 10 when a failure occurs in the component. A component which stops the operation of the image forming apparatus 10 when a failure occurs in the component is also called a “critical component” because a failure in the component exerts a larger influence than the other components.

The process performed by the abnormal-noise detection unit 13 is implemented through operations of a detection controller 13A, a noise collection controller 13B, a frequency analysis unit 13C, and an abnormal-noise determination unit 13D which are included in the abnormal-noise detection unit 13.

The noise collection controller 13B controls the microphone 17 in accordance with instructions from the detection controller 13A, and obtains operational noise data.

The frequency analysis unit 13C performs frequency analysis on operational noise data obtained by the noise collection controller 13B, and generates frequency analysis data 8. The frequency analysis data 8 indicates time-series change of frequency components in operational noise data, and is also called short-time Fourier transform (STFT) data. Frequency components in operational noise data are obtained through time Fourier transform performed on the operational noise data.

The abnormal-noise determination unit 13D compares normal-condition data with frequency analysis data 8, which is obtained by the frequency analysis unit 13C, to determine whether an abnormality occurs in operations of the image forming unit 37D. The normal-condition data is frequency analysis data 8 for operational noise data having noise collected by the microphone 17 in advance under the condition in which the image forming unit 37D operates normally. That is, the normal-condition data is frequency analysis data 8 for an image formation period 5 of the image forming unit 37D in normal operation. “Abnormal noise” determined by the abnormal-noise determination unit 13D refers to noise different from noise caused by the image forming unit 37D in normal operation, that is, normal noise.

When an abnormality is recognized in the image forming unit 37D's operation, the abnormal-noise determination unit 13D notifies the detection controller 13A of occurrence of the abnormality.

The detection controller 13A controls each of the noise collection controller 13B, the frequency analysis unit 13C, and the abnormal-noise determination unit 13D to perform processing in the abnormal-noise detection unit 13. In addition, when the detection controller 13A receives, from the abnormal-noise determination unit 13D, a notification of occurrence of an abnormality in the image forming unit 37D, the detection controller 13A outputs, to the apparatus controller 15, a notification of occurrence of an abnormality. When the determination result indicates occurrence of an abnormality, the detection controller 13A also outputs, to the apparatus controller 15, analysis target data of the designated component.

When the apparatus controller 15 receives, from the detection controller 13A, a notification of occurrence of an abnormality, the apparatus controller 15 outputs, to the failure determination unit 14, the analysis target data of the designated component, which has been received from the detection controller 13A.

The failure determination unit 14 uses the analysis target data of the designated component, which has been received from the apparatus controller 15, to determine whether a failure has occurred in the designated component, that is, to determine presence of the failure state of the designated component, and outputs the determination result to the apparatus controller 15. The failure determination unit 14 is an exemplary determination unit provided in the present disclosure.

The failure determination unit 14 may determine presence of the failure state of a component different from the designated component in the image forming unit 37D. The details will be described below.

When the apparatus controller 15 receives, from the failure determination unit 14, a notification that a failure has occurred in the designated component, the apparatus controller 15 controls the communication unit 11 so that the notification of occurrence of a failure in the designated component is transmitted to the management server 20.

Thus, the apparatus controller 15 controls the functional units of the communication unit 11, the image forming unit 12, the abnormal-noise detection unit 13, and the failure determination unit 14 so that the image forming apparatus 10 determines presence of the failure state of the designated component, which is included in the image forming unit 37D, from operational noise of the image forming unit 37D.

The storage device 16 includes an operational noise database (DB) 16A, a determination DB 16B, and a history DB 16C. The abnormal-noise detection unit 13 stores and retrieves various data in/from the storage device 16.

The noise collection controller 13B stores, in the operational noise DB 16A, operational noise data of the image forming unit 37D.

The determination DB 16B stores data, such as frequency analysis data 8, which is used in detection of abnormal noise in the image forming unit 37D and in determination about presence of the failure state of the designated component.

The history DB 16C stores operational logs of the image forming apparatus 10. The operational logs are generated by the apparatus controller 15 and are stored in the history DB 16C by the detection controller 13A which receives the operational logs from the apparatus controller 15. An operational log of the image forming apparatus 10 is an exemplary operational history in which the operating condition of the corresponding component included in the image forming apparatus 10 is recorded. Since the image forming unit 37D is included in the image forming apparatus 10, the operational logs of the image forming apparatus 10 also include operational logs of the image forming unit 37D in which the operating conditions of the components included in the image forming unit 37D are recorded. An operational log is an exemplary operational history in the present disclosure.

By referring to various data stored in the operational noise DB 16A, the determination DB 16B, and the history DB 16C, the abnormal-noise detection unit 13 detects abnormal noise occurring in the image forming unit 37D in an image formation period 5, and the failure determination unit 14 determines presence of the failure state of the designated component.

When the management server 20 receives, from the image forming apparatus 10, a notification of occurrence of a failure in the designated component, for example, the management server 20 transmits, to a maintenance terminal which is installed in a division for maintenance of the image forming apparatus 10, a replacement instruction to replace the designated component. The maintenance terminal is an exemplary external apparatus connected to the communication line 2. A maintenance person who has received the replacement instruction may go to the image forming apparatus 10 in which a failure has occurred, and may replace the designated component.

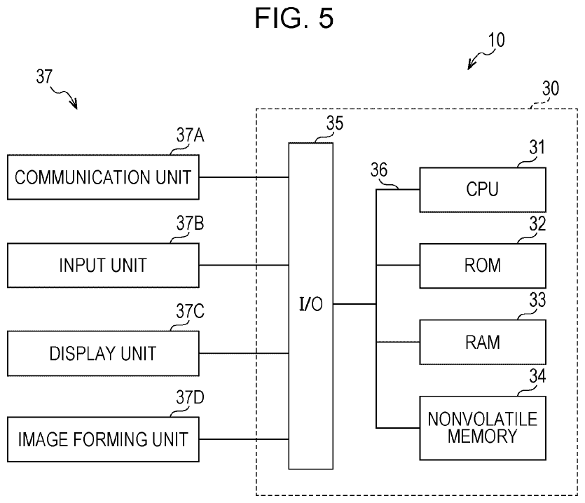

The image forming apparatus 10 and the management server 20, which perform such processing, may be configured by using a computer 30 and a computer 40, respectively. FIG. 5 is a diagram illustrating an exemplary partial configuration of an electrical system of the image forming apparatus 10 configured by using the computer 30.

The computer 30 includes a central processing unit (CPU) 31 which is an exemplary first processor which performs the processes of the functional units in the image forming apparatus 10 illustrated in FIG. 2, a read only memory (ROM) 32 which stores a boot program (basic input output system: BIOS) which boots the computer 30, a random access memory (RAM) 33 which is used as a temporary work area of the CPU 31, a nonvolatile memory 34, and an input/output interface (I/O) 35. The CPU 31, the ROM 32, the RAM 33, the nonvolatile memory 34, and the I/O 35 are connected to each other through a bus 36.

The nonvolatile memory 34, which is an exemplary storage device 16 which maintains stored information even after a shutdown of power supplied to the nonvolatile memory 34, is, for example, a semiconductor memory, or may be a hard disk.

The I/O 35 is connected, for example, to units 37 which have configurations for implementing functions provided by the image forming apparatus 10. In the example in FIG. 5, the I/O 35 is connected to a communication unit 37A, an input unit 37B, a display unit 37C, and the image forming unit 37D.

The communication unit 37A is connected to the communication line 2, and has communication protocols for data communication with apparatuses such as the management server 20 connected to the communication line 2.

The input unit 37B is an exemplary unit 37 which receives user operations and transmits notifications to the CPU 31, and is, for example, buttons and a touch panel.

The display unit 37C is an exemplary unit 37 which visually displays information processed by the CPU 31, and is, for example, a liquid-crystal display or an organic light-emitting diode (OLED) display.

As described above by using FIG. 3, the image forming unit 37D is an exemplary unit 37 which forms an image on a sheet P by using color material.

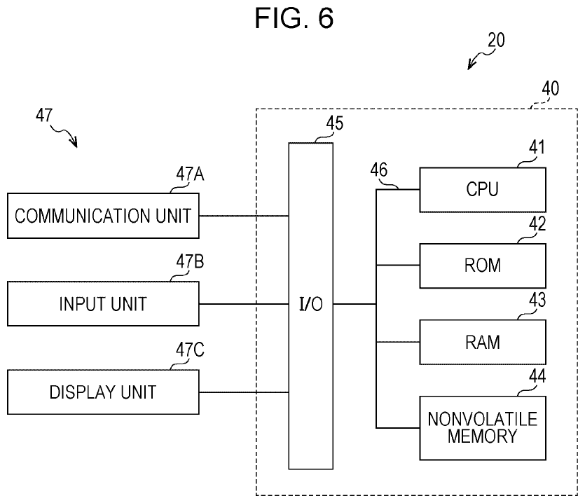

FIG. 6 is a diagram illustrating an exemplary partial configuration of an electrical system of the management server 20 configured by using the computer 40.

The computer 40 includes a CPU 41 which is an exemplary second processor which performs the processes of the management server 20, a ROM 42 which stores a BIOS which boots the computer 40, a RAM 43 which is used as a temporary work area of the CPU 41, a nonvolatile memory 44, and an I/O 45. The CPU 41, the ROM 42, the RAM 43, the nonvolatile memory 44, and the I/O 45 are connected to each other through a bus 46.

The I/O 45 is connected, for example, to units 47 which have configurations for implementing functions provided by the management server 20. In the example in FIG. 6, the I/O 45 is connected to a communication unit 47A, an input unit 47B, and a display unit 47C.

The communication unit 47A is connected to the communication line 2 and has communication protocols for data communication with apparatuses such as each image forming apparatus 10 connected to the communication line 2.

The input unit 47B is an exemplary unit 47 which receives operations of a manager who manages the management server 20 and transmits notifications to the CPU 41, and is, for example, a keyboard and a mouse.

The display unit 47C is an exemplary unit 47 which visually displays information processed by the CPU 41. Like the display unit 37C of the image forming apparatus 10, the display unit 47C is, for example, a liquid-crystal display or an organic light-emitting diode (OLED) display.

Operation of abnormality detection performed by the image forming apparatus 10 will be described.

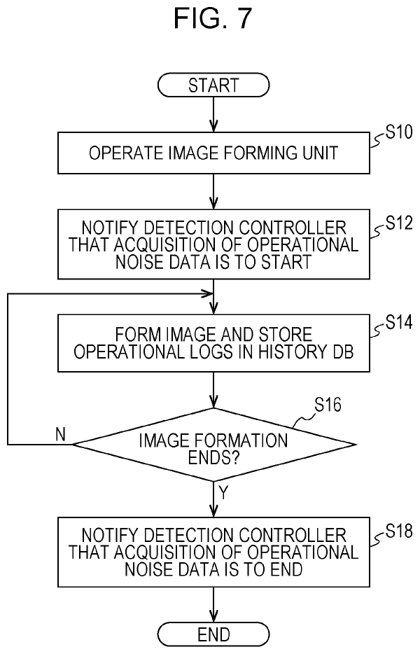

FIG. 7 is a flowchart of an exemplary process of starting abnormality detection. The abnormality-detection start process is performed by the apparatus controller 15 of an image forming apparatus 10 when an instruction to form an image on a sheet P is received from a user.

A processing program, in which the abnormality-detection start process is defined, is, for example, stored in advance in the nonvolatile memory 34 of the image forming apparatus 10. The CPU 31 of the image forming apparatus 10 reads the processing program stored in the nonvolatile memory 34, and performs the abnormality-detection start process.

For example, it is assumed that the operational noise DB 16A, the determination DB 16B, and the history DB 16C are constructed in the nonvolatile memory 34. Alternatively, the operational noise DB 16A, the determination DB 16B, and the history DB 16C may be constructed in an external apparatus. In this case, the image forming apparatus 10 accesses the operational noise DB 16A, the determination DB 16B, and the history DB 16C through the communication line 2.

In step S10, when the apparatus controller 15 receives, from a user, an instruction to form an image, the apparatus controller 15 controls and operates the image forming unit 37D so that a single sheet P is transported from the sheet container 3.

When the detection sensor 6A detects the leading end of the sheet P, in step S12, the apparatus controller 15 notifies the detection controller 13A that acquisition of operational noise data of the image forming unit 37D is to start.

In step S14, the apparatus controller 15 controls the image forming unit 37D so that an image is formed on the sheet P. At the same time, the apparatus controller 15 generates operational logs of the image forming apparatus 10, and stores the generated operational logs in the history DB 16C via the detection controller 13A. Independently from the position of the sheet P, while the power supply of the image forming apparatus 10 is switched on, the operational logs of the image forming apparatus 10 are generated by the apparatus controller 15.

In step S16, the apparatus controller 15 determines whether image formation on the sheet P has ended. When the detection sensor 6B detects the trailing end of the sheet P, the apparatus controller 15 determines that image formation on the sheet P has ended. If image formation has not ended, the process proceeds to step S14, and image formation on the sheet P continues. At the same time, the operational logs of the image forming apparatus 10 are generated.

In contrast, if it is determined that image formation has ended in the determination process in step S16, the process proceeds to step S18.

In step S18, the apparatus controller 15 notifies the detection controller 13A that acquisition of operational noise data of the image forming unit 37D is to end.

Thus, the abnormality-detection start process ends. The abnormality-detection start process is performed for preparation for detection as to whether the image forming unit 37D has an abnormality.

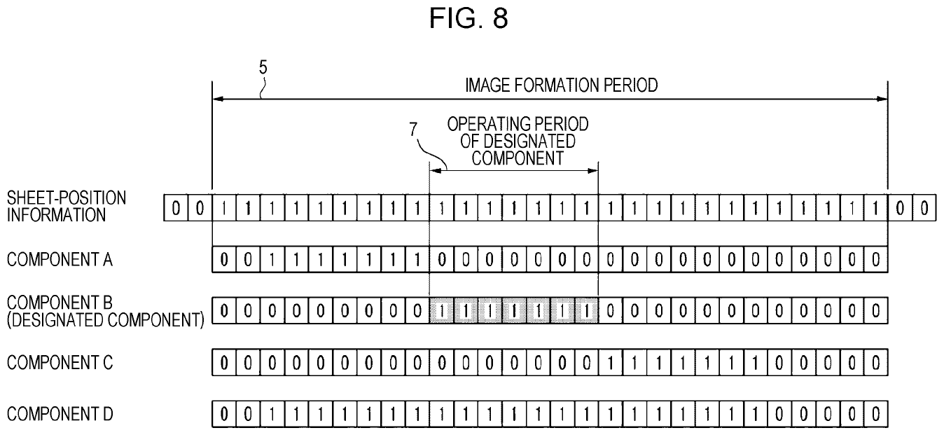

FIG. 8 is a diagram illustrating exemplary operational logs. The operational logs illustrated in FIG. 8 are exemplary operational logs corresponding to the image forming unit 37D illustrated in FIG. 3. Each operational log is illustrated on a time-series basis in the left-to-right direction in FIG. 8.

Sheet-position information is an operational log describing whether either one or both of the leading end and the trailing end of a sheet P is present on the transport path between the detection sensor 6A and the detection sensor 6B. When either one or both of the leading end and the trailing end of a sheet P is present on the transport path between the detection sensor 6A and the detection sensor 6B, for example, sheet-position information is set to “1”.

Otherwise, for example, sheet-position information is set to “0”. That is, a period for which sheet-position information is set to “1” indicates an image formation period 5.

In the operational logs of the components A to D, “0” indicates the state in which the corresponding component is not operating; “1” indicates the state in which the corresponding component is operating. Therefore, for example, a period for which “1” is set in the operational log of component B indicates an operating period of component B.

When the detection controller 13A receives, from the apparatus controller 15, a notification that operational noise data of the image forming unit 37D is to be obtained, the detection controller 13A instructs the noise collection controller 13B to obtain operational noise data. When the detection controller 13A receives, from the apparatus controller 15, a notification that acquisition of operational noise data of the image forming unit 37D is to end, the detection controller 13A instructs the noise collection controller 13B to end acquisition of operational noise data.

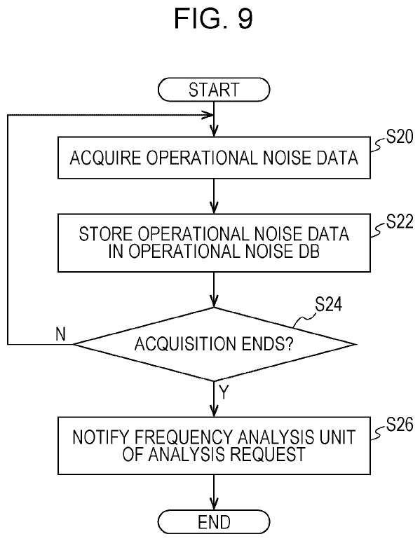

FIG. 9 is a flowchart of an exemplary process of acquiring operational noise data. The operational-noise-data acquisition process is performed by the noise collection controller 13B of the image forming apparatus 10 when an instruction to acquire operational noise data is received from the detection controller 13A.

A processing program, in which the operational-noise-data acquisition process is defined, is, for example, stored in advance in the nonvolatile memory 34 of the image forming apparatus 10. The CPU 31 of the image forming apparatus 10 reads the processing program stored in the nonvolatile memory 34, and performs the operational-noise-data acquisition process.

In step S20, the noise collection controller 13B acquires operational noise data of the image forming unit 37D through the microphone 17.

In step S22, the noise collection controller 13B stores, in the operational noise DB 16A, the operational noise data obtained in step S20.

In step S24, the noise collection controller 13B determines whether the noise collection controller 13B has received, from the detection controller 13A, an instruction to end acquisition of operational noise data. If an instruction to end acquisition of operational noise data has not been received, the process proceeds to step S20, and operational noise data of the image forming unit 37D continues to be acquired. In contrast, if an instruction to end acquisition of operational noise data has been received, the process proceeds to step S26.

In step S26, the noise collection controller 13B notifies the frequency analysis unit 13C of a request to analyze the operational noise data acquired in step S20, and ends the operational-noise-data acquisition process illustrated in FIG. 9.

Thus, operational noise data of the image forming unit 37D for an image formation period 5 is obtained.

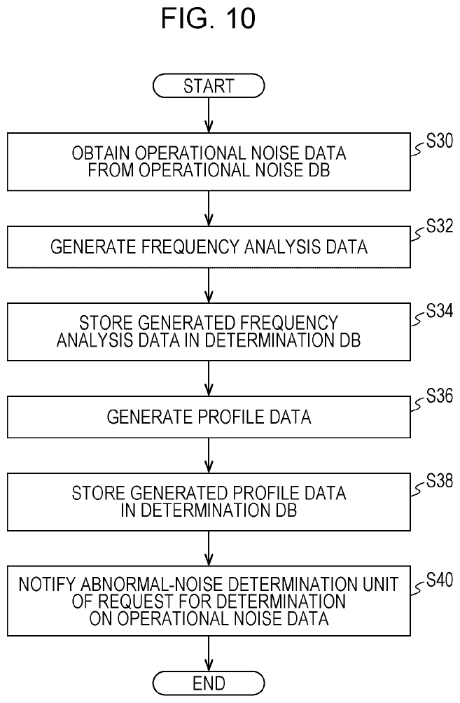

FIG. 10 is a flowchart of an exemplary process of analyzing operational noise data. The operational-noise-data analysis process is performed by the frequency analysis unit 13C of the image forming apparatus 10 when a request to analyze operational noise data is transmitted from the noise collection controller 13B.

A processing program, in which the operational-noise-data analysis process is defined, is, for example, stored in advance in the nonvolatile memory 34 of the image forming apparatus 10. The CPU 31 of the image forming apparatus 10 reads the processing program stored in the nonvolatile memory 34, and performs the operational-noise-data analysis process.

In step S30, the frequency analysis unit 13C obtains operational noise data of the image forming unit 37D for the image formation period 5, which is stored in the operational noise DB 16A by the noise collection controller 13B in step S22 in FIG. 9.

In step S32, the frequency analysis unit 13C performs frequency analysis on the operational noise data obtained in step S30, and generates frequency analysis data 8.

In step S34, the frequency analysis unit 13C stores, in the determination DB 16B, the frequency analysis data 8, which has been generated in step S32, in association with the operational noise data.

In step S36, the frequency analysis unit 13C generates profile data 9 from the frequency analysis data 8 generated in step S32. The profile data 9 describes sound pressure levels for each frequency and at each time included in the operational noise data.

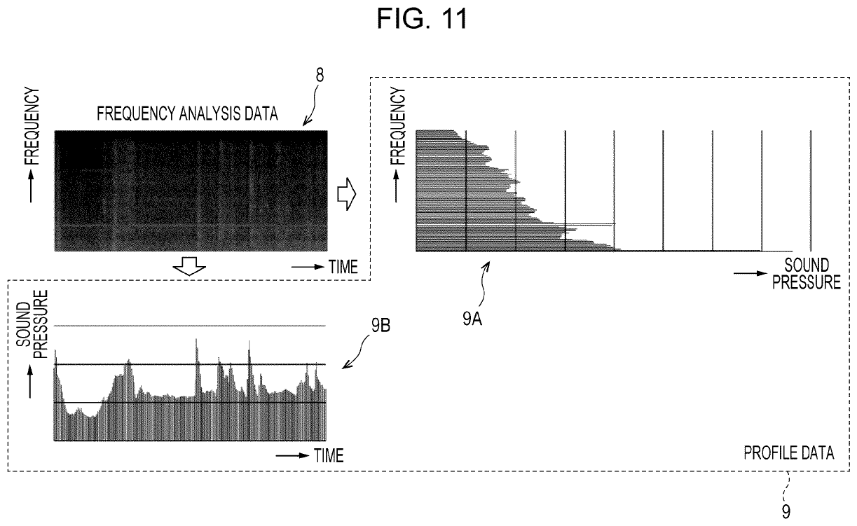

FIG. 11 is a diagram illustrating exemplary profile data 9. As illustrated in FIG. 11, the profile data 9 is constituted by frequency to sound pressure data 9A, which describes sound pressure level for each frequency, and time to sound pressure data 9B, which describes sound pressure level at each time. The frequency analysis data 8 describes the frequency distribution for the entire image formation period 5. Thus, the profile data 9 also describes sound pressure level for each frequency and sound pressure level at each time for the entire image formation period 5.

In step S38, the frequency analysis unit 13C stores, in the determination DB 16B, the profile data 9, which is generated in step S36, in association with the frequency analysis data 8 from which the profile data 9 is generated.

In step S40, the frequency analysis unit 13C notifies the abnormal-noise determination unit 13D of a determination request to determine whether the operational noise data contains abnormal noise, and ends the operational-noise-data analysis process illustrated in FIG. 10.

Thus, the frequency analysis data 8 and the profile data 9 for the operational noise data of the image forming unit 37D for an image formation period 5 are obtained.

In the operational-noise-data analysis process, it is not necessary to generate profile data 9. The frequency analysis unit 13C may generate only frequency analysis data 8.

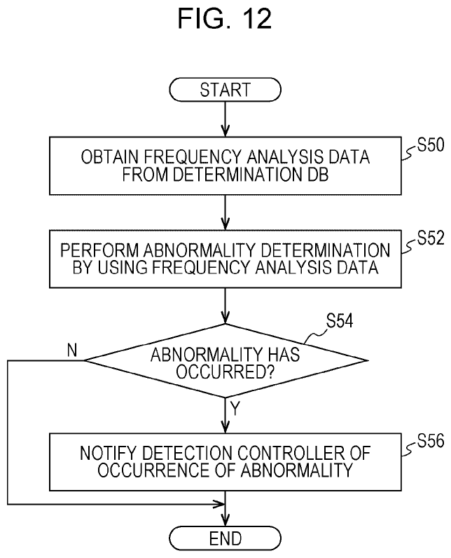

FIG. 12 is a flowchart of an exemplary process of determining abnormal noise. The abnormal-noise determination process is performed by the abnormal-noise determination unit 13D of the image forming apparatus 10 when a request for determination on operational noise data is received from the frequency analysis unit 13C.

A processing program, in which the abnormal-noise determination process is defined, is, for example, stored in advance in the nonvolatile memory 34 of the image forming apparatus 10. The CPU 31 of the image forming apparatus 10 reads the processing program stored in the nonvolatile memory 34, and performs the abnormal-noise determination process.

In step S50, the abnormal-noise determination unit 13D obtains the frequency analysis data 8 stored in the determination DB 16B in step S34 in FIG. 10.

In step S52, the abnormal-noise determination unit 13D compares normal-condition data with the frequency analysis data 8 obtained in step S50. When the difference between the frequency analysis data and the normal-condition data is greater than or equal to a predetermined threshold, the abnormal-noise determination unit 13D determines that an abnormality has occurred in the operations of the image forming unit 37D.

In step S54, if the abnormal-noise determination unit 13D determines that an abnormality has occurred in the operations of the image forming unit 37D, the process proceeds to step S56.

In step S56, the abnormal-noise determination unit 13D notifies the detection controller 13A of occurrence of an abnormality in the image forming unit 37D, and ends the abnormal-noise determination process illustrated in FIG. 12. The abnormal-noise determination unit 13D also notifies the detection controller 13A of information for identifying the image formation period 5 in which the occurrence of an abnormality is recognized.

In the determination process in step S54, if it is determined that an abnormality in the operations of the image forming unit 37D is not recognized, the process in step S56 is not performed, and the abnormal-noise determination process illustrated in FIG. 12 ends.

Thus, presence of an abnormality in the image forming unit 37D is determined from frequency analysis data 8 obtained from operational noise data. The manufacturer of the image forming apparatus 10 may store the normal-condition data in advance in the determination DB 16B before shipment from the factory. Alternatively, the normal-condition data may be obtained from the management server 20. The case in which the normal-condition data is obtained from the management server 20 allows update of the normal-condition data.

In the determination about occurrence of an abnormality in the image forming unit 37D, the abnormal-noise determination unit 13D does not determine which failure has occurred in which component included in the image forming unit 37D. Therefore, compared with the case in which a failed component is determined, the load on the CPU 31 is reduced. This allows determination about presence of an abnormality in the image forming unit 37D for every image formation on a sheet P even when the image forming unit 37D forms images continuously on multiple sheets P.

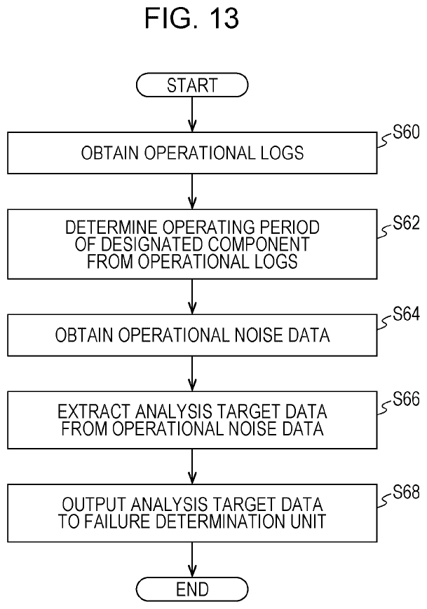

FIG. 13 is a flowchart of an exemplary process of extracting analysis target data. The analysis-target-data extraction process is performed by the detection controller 13A of the image forming apparatus 10 when a notification of occurrence of an abnormality in the image forming unit 37D is received from the abnormal-noise determination unit 13D.

A processing program, in which the analysis-target-data extraction process is defined, is, for example, stored in advance in the nonvolatile memory 34 of the image forming apparatus 10. The CPU 31 of the image forming apparatus 10 reads the processing program stored in the nonvolatile memory 34, and performs the analysis-target-data extraction process.

In step S60, the detection controller 13A obtains, from the history DB 16C, the operational logs of the image forming unit 37D for the image formation period 5 in which the notification indicates that an abnormality has occurred.

In step S62, the detection controller 13A refers to the operational logs obtained in step S60, and determines the operating period of the predetermined designated component included in the image forming unit 37D. For example, when component B is set to the designated component, a period 7 in FIG. 8 is the operating period of the designated component.

In step S64, the detection controller 13A obtains, from the operational noise DB 16A, the operational noise data for the image formation period 5 in which the notification indicates that an abnormality has occurred.

In step S66, the detection controller 13A extracts, as analysis target data, operational noise data, which corresponds to the operating period of the designated component which is determined in step S62, from the operational noise data obtained in step S64.

In step S68, the detection controller 13A outputs, to the failure determination unit 14 via the apparatus controller 15, the analysis target data obtained through extraction from the operational noise data in step S66, and ends the analysis-target-data extraction process illustrated in FIG. 13.

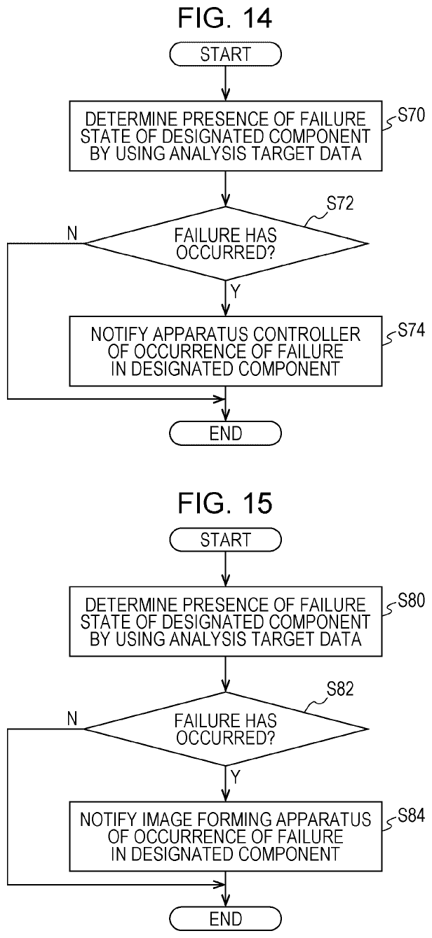

FIG. 14 is a flowchart of an exemplary process of determining presence of a failure in the designated component. The designated-component failure determination process is performed by the failure determination unit 14 of the image forming apparatus 10 when analysis target data is received from the detection controller 13A via the apparatus controller 15.

A processing program, in which the designated-component failure determination process is defined, is, for example, stored in advance in the nonvolatile memory 34 of the image forming apparatus 10. The CPU 31 of the image forming apparatus 10 reads the processing program stored in the nonvolatile memory 34, and performs the designated-component failure determination process.

In step S70, the failure determination unit 14 uses the received analysis target data to determine presence of the failure state of the designated component. To determine whether a failure has occurred in the designated component, a known determination technique for determining the state of a component from operational noise is used. In such a technique, for example, analysis target data is compared with operational noise data obtained in the condition in which the designated component operates normally. Operational noise may be different depending on the type of a failure. Thus, when it is determined that a failure has occurred in the designated component, for example, the failure determination unit 14 may compare analysis target data with pieces of operational noise data, which are associated with the types of various failures, to determine the type of a failure which has occurred in the designated component.

The analysis target data for an operating period of the designated component is operational noise data. Thus, for example, the analysis target data contains a larger amount of information than data such as frequency analysis data 8 which is obtained through some processing on operational noise data. Therefore, presence of the failure state of the designated component is determined more specifically and more accurately than in determination about presence of the failure state of the designated component using frequency analysis data 8.

In addition, instead of determination about presence of the failure state of the designated component using the entire operational noise data for an image formation period 5, presence of the failure state of the designated component is determined by using operational noise data corresponding to the operating period of the designated component. Thus, compared with determination about presence of the failure state of the designated component using the entire operational noise data for an image formation period 5, the load for determination about presence of a failure in the designated component is reduced.

In step S72, if the failure determination unit 14 determines that a failure has occurred in the designated component, the process proceeds to step S74.

In step S74, the failure determination unit 14 notifies the apparatus controller 15 of occurrence of a failure in the designated component. The apparatus controller 15, which has received the notification of occurrence of a failure, controls the communication unit 37A so that a notification of occurrence of a failure in the designated component is transmitted to the management server 20.

In contrast, in the determination process in step S72, if it is determined that a failure in the designated component is not recognized, the process in step S74 is not performed, and the designated-component failure determination process illustrated in FIG. 14 ends. In this case, the failure determination unit 14 may notify the apparatus controller 15 that no failures have occurred in the designated component. The apparatus controller 15, which has received the notification that no failures have occurred in the designated component, may control the communication unit 37A so that a notification that the designated component operates normally is transmitted to the management server 20.

Thus, presence of the failure state of the designated component in the image forming unit 37D is determined. It is not necessary for the failure determination unit 14 to determine presence of the failure state of the designated component every time the image forming unit 37D forms an image on a sheet P. For example, in printing of a document having multiple pages, the failure determination unit 14 may perform the designated-component failure determination process after completion of printing of all the pages of the document. In addition, the failure determination unit 14 may perform the designated-component failure determination process at every predetermined time.

The image forming unit 37D includes multiple components which cooperate with each other to form an image. Thus, a component different from the designated component may operate in the operating period of the designated component. In such a condition in which multiple components operate in the operating period of the designated component, when, in step S70 in FIG. 14, the failure determination unit 14 determines that analysis target data contains data indicating occurrence of a failure in a component, the failure determination unit 14 may transmit, to the management server 20 via the apparatus controller 15, a determination result indicating that a failure has occurred in any of the components which operate in the operating period of the designated component. That is, the failure determination unit 14 lists, as component candidates which may have a failure, the components in the image forming unit 37D which operate in the operating period of the designated component. The operating period of each component may be obtained by referring to their operational logs.

In the description above, a critical component, which is designated in advance by a manager, is used as the designated component. Alternatively, the detection controller 13A may change the designated component, for example, in accordance with the accumulated operating times in the image forming unit 37D. The components included in the image forming unit 37D are different in service life in specification. Therefore, the detection controller 13A may set a component, which is close to its service life, to the designated component. When the designated component is set as described above, presence of the failure state is determined by focusing on a component in which a failure occurs more easily than the other components. Thus, compared with the case in which a component which is a target of failure-state determination is not allowed to be changed, a malfunction in the image forming unit 37D is detected quickly.

### First Modified Example

The example in which presence of the failure state of the designated component is determined is described. If a different component operates in the same period as an operating period of the designated component, the image forming apparatus 10 transmits a notification that a failure may occur also in the different component.

In contrast, presence of the failure state may be to be determined also for a different component which operates in a period (referred to as a “designated-component non-operating period”) different from an operating period of the designated component in an image formation period 5.

Therefore, the image forming apparatus 10, which determines presence of the failure state of a component in the image forming unit 37D also in a designated-component non-operating period, will be described below.

Specifically, in step S60 in the analysis-target-data extraction process illustrated in FIG. 13, the detection controller 13A obtains operational logs of the image forming unit 37D, and further obtains, from the determination DB 16B, the profile data 9 associated with the frequency analysis data 8 used in the determination about presence of an abnormality in the image forming unit 37D.

In addition, in step S68, the detection controller 13A outputs, to the failure determination unit 14 via the apparatus controller 15, the obtained profile data 9 as well as the analysis target data.

In contrast, in step S70 in the designated-component failure determination process illustrated in FIG. 14, the failure determination unit 14 determines presence of the failure state of the designated component, and further uses the profile data 9 to determine presence of the failure state of a different component in the image forming unit 37D which operates in the designated-component non-operating period.

In step S72, if the failure determination unit 14 determines that a failure has occurred in any of the designated component and the different component, the process proceeds to step S74.

In step S74, the failure determination unit 14 notifies the apparatus controller 15 of occurrence of a failure in either one or both of the designated component and the different component, in accordance with the condition of occurrence of a failure.

Therefore, the determination result about presence of the failure state of a different component in the image forming unit 37D which operates in the designated-component non-operating period is output to the management server 20.

Profile data 9 has a smaller amount of information than operational noise data in the same period. Thus, compared with the case in which presence of the failure state of a different component which operates in the designated-component non-operating period is determined by using operational noise data, the load for determination about presence of the failure state is reduced.

In the designated-component non-operating period, multiple components different from the designated component may operate. In the condition in which multiple different components operate in the designated-component non-operating period, when the failure determination unit 14 uses the profile data 9 to determine that the profile data 9 indicates occurrence of a failure in a component in the designated-component non-operating period, the failure determination unit 14 may transmit, to the management server 20 via the apparatus controller 15, the determination result indicating that a failure has occurred in any of the components which operate in the designated-component non-operating period. That is, the failure determination unit 14 lists, as component candidates which may have a failure, components which are different from the designated component in the image forming unit 37D and which operate in the designated-component non-operating period.

### Second Modified Example

FIG. 2 illustrates the image forming apparatus 10 including the failure determination unit 14. However, the image forming apparatus 10 does not necessarily include the failure determination unit 14. Alternatively, the management server 20 may include the failure determination unit 14. That is, the management server 20 may determine presence of the failure state of the designated component included in the image forming apparatus 10.

In this case, in step S68 in the analysis-target-data extraction process illustrated in FIG. 13, the detection controller 13A of the image forming apparatus 10 may transmit, to the management server 20 via the apparatus controller 15, the analysis target data extracted from operational noise data in step S66.

FIG. 15 is a flowchart of an exemplary designated-component failure determination process performed by the failure determination unit 14 of the management server 20 when analysis target data is received from the image forming apparatus 10.

A management program, in which the designated-component failure determination process is defined, is, for example, stored in advance in the nonvolatile memory 44 of the management server 20. The CPU 41 of the management server 20 reads the management program stored in the nonvolatile memory 44, and performs the designated-component failure determination process.

In step S80, the failure determination unit 14 of the management server 20 uses the analysis target data, which has been received, to determine presence of the failure state of the designated component. To determine whether a failure has occurred in the designated component, a known determination technique for determining the state of a component from operational noise is used.

In step S82, if the failure determination unit 14 of the management server 20 determines that a failure has occurred in the designated component, the process proceeds to step S84.

In step S84, the failure determination unit 14 of the management server 20 notifies the image forming apparatus 10 of occurrence of a failure in the designated component. The apparatus controller 15 of the image forming apparatus 10, which has received the notification of occurrence of a failure, controls, for example, the display unit 37C so that a message, which indicates that an abnormality has occurred in the image forming unit 37D, and the name of a component that may have the failure are displayed on the display unit 37C.

In contrast, in the determination process in step S82, if it is determined that no failures have occurred in the designated component, the process in step S84 is not performed, and the designated-component failure determination process illustrated in FIG. 15 ends. In this case, the failure determination unit 14 of the management server 20 may notify the image forming apparatus 10 that no failures have occurred in the designated component.

Thus, presence of the failure state of the designated component in the image forming unit 37D is determined. The management server 20 determines presence of the failure state of the designated component. Thus, compared with the case in which the image forming apparatus 10 determines presence of the failure state of the designated component, a lighter load is placed on the image forming apparatus 10. Therefore, for example, more than necessary throughput of the CPU 31 in the image forming apparatus 10 and more than necessary capacity of the RAM 33 are not required, resulting in a reduction in cost of the image forming apparatus 10.

As described in the first modified example, the failure determination unit 14 of the management server 20 may use the profile data 9, which has been received from the image forming apparatus 10, to determine presence of the failure state of a different component in the image forming unit 37D which operates in the designated-component non-operating period, and may notify the image forming apparatus 10 of the determination result.

An aspect of the management system 1 is described by using the exemplary embodiment. The disclosed aspect of the management system 1 is exemplary. The aspect of the management system 1 is not limited to the scope described in the exemplary embodiment. Various changes and improvements may be made to the exemplary embodiment without departing from the gist of the present disclosure. Embodiment obtained by adding the changes or improvements is also encompassed in the technical scope of the present disclosure.

For example, the internal processing order in the processes illustrated in FIGS. 7, 9, 10 and 12 to 15 may be changed without departing from the gist of the present disclosure. In addition, an apparatus which is a target of abnormality detection is not limited to the image forming unit 37D. When the image forming apparatus 10 has a scan function, a component, in a scan unit, that moves, over a document, a light source unit which radiates light and that optically reads the content of the document is designated as the designated component. Thus, presence of an abnormality may be detected in the scan unit.

In the exemplary embodiment described above, for example, the processes illustrated in FIGS. 7, 9, 10 and 12 to 15 are implemented by using software. Alternatively, processes equivalent to the flowcharts of the processes may be performed by using hardware. In this case, compared with the case in which the processes are implemented by using software, further increases in speed of the processes are achieved.

In the embodiments above, the term “processor” refers to hardware in a broad sense. Examples of the processor include general processors (e.g., the CPU 31, 41) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the exemplary embodiments described above, the example in which the processing programs are stored in the nonvolatile memory 34 is described. However, the destination of storage of the processing programs is not limited to the nonvolatile memory 34. The processing programs provided by the present disclosure may be provided in the form in which the processing programs are recorded in a storage medium readable by the computer 30.

For example, the processing programs may be provided in the form in which the processing programs are recorded in an optical disk, such as a compact disk read only memory (CD-ROM) or a digital versatile disk read only memory (DVD-ROM). Information processing programs may be provided in the form in which the information processing programs are recorded in a portable semiconductor memory, such as a Universal Serial Bus (USB) memory or a memory card. The ROM 32, the nonvolatile memory 34, a CD-ROM, a DVD-ROM, a USB, and a memory card are exemplary non-transitory storage media.

Similarly, the management program may be provided in the form in which the management program is recorded in a storage medium readable by the computer 40.

Further, the image forming apparatus 10 may download, through the communication unit 37A, the processing programs from an external apparatus connected to the communication line 2, and may store the downloaded processing programs in the nonvolatile memory 34. In this case, the CPU 31 of the image forming apparatus 10 reads, from the nonvolatile memory 34, the processing programs downloaded from the external apparatus, and performs the various processes.

Similarly, the management server 20 may download, through the communication unit 47A, the management program from an external apparatus connected to the communication line 2, and may store the download management program in the nonvolatile memory 44.

### Appendix

(((1)))

A processing apparatus comprising:
a processor configured to:
   obtain operational noise data for a predetermined period, the operational noise data being obtained in operation of the apparatus which makes noise caused by the operation;
   in response to detection of an abnormality in the apparatus from the operational noise data, extract, as analysis target data from the operational noise data, data corresponding to an operating period of a designated component that is designated in advance and that is included in the apparatus; and
   output the extracted analysis target data to a determination unit that determines presence of a failure state of the designated component.
      (((2)))

The processing apparatus according to (((1))),
wherein the processor is configured to:
   generate profile data representing sound pressure level for each frequency and sound pressure level at each time, the sound pressure levels being included in the operational noise data; and
   in response to detection of an abnormality in the apparatus from the operational noise data, output the analysis target data and the profile data to the determination unit that determines presence of the failure state of the designated component.
      (((3)))

The processing apparatus according to (((2))),
wherein the designated component is a component that stops the operation of the apparatus when a failure occurs in the component.
   (((4)))

The processing apparatus according to (((3))), comprising:
the determination unit,
wherein the processor is configured to:
   by using the determination unit, determine presence of the failure state of the designated component from the analysis target data; and
   output, to a management apparatus, a determination result about presence of the failure state of the designated component.
      (((5)))

The processing apparatus according to (((4))),
wherein the processor is configured to:
   when a plurality of components included in the apparatus operate in the operating period of the designated component and when the analysis target data contains data indicating occurrence of a failure in a component, output, to the management apparatus, a determination result indicating that a failure occurs in any of the plurality of components which operate in the operating period of the designated component.
      (((6)))

The processing apparatus according to (((4))),
wherein the processor is configured to:
   by using the determination unit, determine, from the profile data, presence of the failure state of a component which operates in a different period other than the operating period of the designated component; and
   output, to the management apparatus, a determination result about presence of the failure state of the component in the different period.
      (((7)))

The processing apparatus according to (((6))),
wherein the processor is configured to:
   when a plurality of components included in the apparatus operate in the different period and when the profile data contains data indicating occurrence of a failure in a component, output, to the management apparatus, a determination result indicating that a failure occurs in any of the plurality of components which operate in the different period.
      (((8)))

The processing apparatus according to (((3))),
wherein, when a management apparatus connected to a communication line includes the determination unit, the processor is configured to:
   output the profile data and the analysis target data to the management apparatus.
      (((9)))

The processing apparatus according to any one of (((1))) to (((8))),
wherein the processor is configured to:
   by using an operational history in which an operating condition of each component included in the apparatus is recorded, obtain an operating period of each component included in the apparatus.
      (((10)))

The processing apparatus according to any one of (((1))) to (((9))),
wherein the processor is configured to:
   change the designated component in accordance with accumulated operating times in the apparatus.
      (((11)))

A non-transitory storage medium storing a program including a command executable by a computer, the command, when executed by the computer, causing the computer to execute a process comprising:
obtaining operational noise data for a predetermined period, the operational noise data being obtained in operation of an apparatus which makes noise caused by the operation;
in response to detection of an abnormality in the apparatus from the operational noise data, extracting, as analysis target data from the operational noise data, data corresponding to an operating period of a designated component that is designated in advance and that is included in the apparatus; and
outputting the extracted analysis target data to a determination unit that determines presence of a failure state of the designated component.
   (((12)))

A management system comprising:
at least one processing apparatus that performs a function requested by a user; and
a management apparatus that manages an operating condition of each of the at least one processing apparatus,
wherein a first processor included in the at least one processing apparatus:
   obtains operational noise data for a predetermined period, the operational noise data being obtained in operation of the processing apparatus which makes noise caused by the operation;
   in response to detection of an abnormality in the processing apparatus from the operational noise data, extracts, as analysis target data from the operational noise data, data corresponding to an operating period of a designated component that is designated in advance and that is included in the processing apparatus; and
   outputs the extracted analysis target data to a determination unit that determines presence of a failure state of the designated component, and
wherein a second processor included in the management apparatus manages, for each of the at least one processing apparatus, presence of the failure state of the designated component by using a determination result obtained by the determination unit.

What is claimed is:

1. A processing apparatus comprising:
a processor configured to:
obtain operational noise data for a predetermined period, the operational noise data being obtained in operation of the apparatus which makes noise caused by the operation;
in response to detection of an abnormality in the apparatus from the operational noise data, extract, as analysis target data from the operational noise data, data corresponding to an operating period of a designated component that is designated in advance and that is included in the apparatus; and
output the extracted analysis target data to a determination unit that determines presence of a failure state of the designated component.

2. The processing apparatus according to claim 1,
wherein the processor is configured to:
generate profile data representing sound pressure level for each frequency and sound pressure level at each time, the sound pressure levels being included in the operational noise data; and
in response to detection of an abnormality in the apparatus from the operational noise data, output the analysis target data and the profile data to the determination unit that determines presence of the failure state of the designated component.

3. The processing apparatus according to claim 2,
wherein the designated component is a component that stops the operation of the apparatus when a failure occurs in the component.

4. The processing apparatus according to claim 3, comprising:
the determination unit,
wherein the processor is configured to:
by using the determination unit, determine presence of the failure state of the designated component from the analysis target data; and
output, to a management apparatus, a determination result about presence of the failure state of the designated component.

5. The processing apparatus according to claim 4,
wherein the processor is configured to:
when a plurality of components included in the apparatus operate in the operating period of the designated component and when the analysis target data contains data indicating occurrence of a failure in a component, output, to the management apparatus, a determination result indicating that a failure occurs in any of the plurality of components which operate in the operating period of the designated component.

6. The processing apparatus according to claim 4,
wherein the processor is configured to:
by using the determination unit, determine, from the profile data, presence of the failure state of a component which operates in a different period other than the operating period of the designated component; and
output, to the management apparatus, a determination result about presence of the failure state of the component in the different period.

7. The processing apparatus according to claim 6,
wherein the processor is configured to:
when a plurality of components included in the apparatus operate in the different period and when the profile data contains data indicating occurrence of a failure in a component, output, to the management apparatus, a determination result indicating that a failure occurs in any of the plurality of components which operate in the different period.

8. The processing apparatus according to claim 3,
wherein, when a management apparatus connected to a communication line includes the determination unit, the processor is configured to:
output the profile data and the analysis target data to the management apparatus.

9. The processing apparatus according to claim 1,
wherein the processor is configured to:
by using an operational history in which an operating condition of each component included in the apparatus is recorded, obtain an operating period of each component included in the apparatus.

10. The processing apparatus according to claim 2,
wherein the processor is configured to:
by using an operational history in which an operating condition of each component included in the apparatus is recorded, obtain an operating period of each component included in the apparatus.

11. The processing apparatus according to claim 3,
wherein the processor is configured to:
by using an operational history in which an operating condition of each component included in the apparatus is recorded, obtain an operating period of each component included in the apparatus.

12. The processing apparatus according to claim 4,
wherein the processor is configured to:
by using an operational history in which an operating condition of each component included in the apparatus is recorded, obtain an operating period of each component included in the apparatus.

13. The processing apparatus according to claim 5,
wherein the processor is configured to:
by using an operational history in which an operating condition of each component included in the apparatus is recorded, obtain an operating period of each component included in the apparatus.

14. The processing apparatus according to claim 6,
wherein the processor is configured to:
by using an operational history in which an operating condition of each component included in the apparatus is recorded, obtain an operating period of each component included in the apparatus.

15. The processing apparatus according to claim 7,
wherein the processor is configured to:
by using an operational history in which an operating condition of each component included in the apparatus is recorded, obtain an operating period of each component included in the apparatus.

16. The processing apparatus according to claim 8,
wherein the processor is configured to:
by using an operational history in which an operating condition of each component included in the apparatus is recorded, obtain an operating period of each component included in the apparatus.

17. A non-transitory computer readable medium storing a processing program causing a computer to execute a process comprising:
obtaining operational noise data for a predetermined period, the operational noise data being obtained in operation of an apparatus which makes noise caused by the operation;
in response to detection of an abnormality in the apparatus from the operational noise data, extracting, as analysis target data from the operational noise data, data corresponding to an operating period of a designated component that is designated in advance and that is included in the apparatus; and
outputting the extracted analysis target data to a determination unit that determines presence of a failure state of the designated component.

18. A management system comprising:
at least one processing apparatus that performs a function requested by a user; and
a management apparatus that manages an operating condition of each of the at least one processing apparatus,
wherein a first processor included in the at least one processing apparatus:
obtains operational noise data for a predetermined period, the operational noise data being obtained in operation of the processing apparatus which makes noise caused by the operation;
in response to detection of an abnormality in the processing apparatus from the operational noise data, extracts, as analysis target data from the operational noise data, data corresponding to an operating period of a designated component that is designated in advance and that is included in the processing apparatus; and
outputs the extracted analysis target data to a determination unit that determines presence of a failure state of the designated component, and
wherein a second processor included in the management apparatus manages, for each of the at least one processing apparatus, presence of the failure state of the designated component by using a determination result obtained by the determination unit.
